(19) United States
(12) Patent Application Publication
(10) Pub. No.: US 2016/0305800 A1
(43) Pub. Date: Oct. 20, 2016

(54) Vortex Flow Measuring Device

(71) Applicant: ENDRESS + HAUSER FLOWTEC AG, Reinach (CH)

(72) Inventors: Rainer Hocker, Waldshut (DE); Michael Carr, Aesch (CH)

(21) Appl. No.: 15/102,977

(22) PCT Filed: Nov. 25, 2014
(86) PCT No.: PCT/EP2014/075450

§ 371 Date: Jun. 9, 2016

(30) Foreign Application Priority Data
Dec. 17, 2013 (DE) 10 2013 114 195.1

(51) Int. Cl. G01F 1/32

(52) U.S. Cl. CPC G01F 1/32

(57) ABSTRACT

A vortex flow measuring device of process automation for ascertaining a process variable, a property of a medium and/or a composition of a medium, comprising at least one sensor unit and one display unit. The sensor unit and the display unit are arranged spatially separated from one another, wherein the display unit and the sensor unit are provided with one or more communication means, which are designed for establishing a wireless data transfer route between the display unit and the sensor unit. At least the communication means of the sensor unit is operated by means of an energy harvester.

The present invention relates to a vortex flow measuring device.

Field devices in general and flow measuring devices in particular are often installed at inaccessible locations, where the local display cannot be read. For this situation, arrangements are applied, in the case of which only the essential measuring electronics are placed on the process line, and the evaluating electronics and display unit are mounted at an easily accessible site. Such an arrangement is also used, when the temperatures near the process line are very high.

A connecting cable between the measuring electronics and the evaluating- and display electronics, in such case, transports both energy for operation of the measuring electronics as well as also the signals and data from the measuring electronics to the evaluating- and display electronics. This cable connection is, as a rule, matched especially to the application and limited in its length for physical and technical reasons.

Known from DE 20107112 U1 is a temperature sensor, which has a thermoelectric converter. This serves for energy supply of the total temperature sensor, thus both a sensor unit as well as also a display- and/or evaluation unit.

Starting from this state of the art, it is an object of the present invention to achieve a greater flexibility relative to the arrangements of sensor unit and display unit in the case of installation and operation of a vortex flow measuring device.

Vortex flow measuring devices are frequently applied in steam lines. These typically have operating temperatures, which lie significantly above ambient temperature. On the other hand, the measuring devices are often installed in inaccessible locations. Here it makes sense to provide the on-site display removed to a location accessible for good readability. For data transmission from the measuring point to the on-site display, a wireless communication is advantageous. Wiring to the measuring point can be omitted, when its energy is won from the temperature difference between operating temperature and ambient temperature. A disadvantage of winning energy from the operating temperature of the fluid is that the energy is not available upon shutdown. In the case of steam lines, this disadvantage is less apparent, since they are first heated for safe operation, before the process flow starts, i.e. a flow display is always possible, since the pipeline is already warm for operation. It remains disadvantageous, however, that during downtimes no information concerning the measuring point is obtainable. The control station can thus not distinguish whether the measuring device is defective or only temporarily possesses no energy. The separated on-site display, which is not being supplied with energy by the energy harvester, can, however, still communicate with the control station via other paths. Thus, it is assured that defective operation and temporary shutdown can be distinguished. This is especially the case when the measuring point logs on and off at the on-site display; wireless communication thus takes place only in the case of need, i.e. when harvested energy is available.

A vortex flow measuring device of the invention for ascertaining a flow related process variable includes a sensor unit and a display unit.

The sensor unit and the display unit are arranged spatially separated from one another. Both are located especially in respective housings, which define the dimensions of the respective unit relative to the environment. In a typical example of application, a pipeline with a medium flowing therein can extend along the ceiling of a factory building. The sensor unit can be arranged on this pipeline in the form of a vortex flow measuring sensor unit. The display unit relative to the measured variable “flow” is arranged at eye level on the wall of the factory building, so that the process technician can comfortably observe it. In such case, the display unit can also contain an evaluation module, respectively an evaluating electronics.

Further according to the invention, the display unit and the sensor unit are provided with one or more communication means, which are designed for establishing a wireless data transfer route between the display unit and the sensor unit of the vortex flow measuring device. Such communication means can include e.g. a radio transmitter and a radio receiver. The separation of the sensor unit and display unit makes sense exactly in locations, where the sensor unit only is difficultly reachable. At such locations, however, the energy supply of the sensor unit and of the connected communication means is likewise problematic. Ideally, consequently, the communication means of the sensor unit should manage with very little energy. Therefore, especially suitable as communication means are transmitters and receivers of near field technology, thus e.g. Bluetooth technology or wireless HART. The low data transmission volume and the short range of the communication means of the near field technology are, indeed, disadvantageous, but, in the case of vortex flow measuring devices not absolutely required, in order to assure a sufficient functionality of the device. At the same time, however, data transmission with little energy consumption is enabled.

According to the invention, at least the communication means of the sensor unit is operated by means of an energy harvester, thus a unit, which wins energy from the process, respectively the process medium. Thus, the sensor unit can be installed at difficultly accessible regions, without that a dedicated energy line for energy supply to the sensor unit must be run. The separate display element, in contrast, can be connected to an energy grid.

The autarkic energy supply of a communication module for the operation of a sensor unit with removed display unit represents a novelty in the field of vortex flow measuring devices. It enables an energy-saving operation, better readability of the measured values and a smaller installation- and maintenance effort, since energy lines for the operation of the sensor unit and especially the operation of the communication unit are unnecessary.

Increased energy requirement in the case of the display unit is required. This can, however, because of the separated manner of construction, be shifted to corresponding energy interfaces of a process control system.

Other advantageous embodiments of the invention are subject matter of the dependent claims.

The frequency of the data transmission between sensor unit and display unit depends not insignificantly on the energy requirement of the communication means of the sensor unit, since here the energy harvester must provide the energy. If the energy yield is too small for continuous data transfer, then the energy must be stored in the interim, in order to permit an intermittent transmission traffic.

As intermittent sending operation in the sense of the present invention is a transmission operation with transmission pauses, a transmission operation to the extent sufficient energy has accumulated or a so called “on demand” transmission operation. In the case of the latter, a measured value is only transmitted, when such is desired by the user. Thus, e.g. the user can actuate a corresponding button on the display unit.

For an energy saving way for the sensor unit to work, it is advantageous when the maximum data transmission rate of the wireless data transfer is equal to or less than 4 Mbit/s, especially 3 Mbit/s. Acting likewise for energy savings is the range of the communication modules. The smaller the range, the less energy required for their operation. It is, consequently, advantageous when the maximum separation between the sensor unit and the display unit is equal to or less than 25 m.

An especially energy saving operation of the vortex flow measuring device results to the extent that the maximum data transmission rate is equal to or less than 1024 Mbit/s and the maximum separation between the sensor unit and the display element is less than or equal to 15 m.

The communication means is preferably a WPAN communication means. WPAN communication technology is governed by the international standard IEEE 802.15 (current version as of December, 2013). Among others, WPAN communication means include Bluetooth transmitters and receivers, as well as IrDA-conforming infrared transmitters and receivers.

Not only the communication means but also the complete sensor unit, thus the measuring transducer and the communication means, can be operated by the harvester. In such case, the energy harvester is utilized as the only energy supply source. As is known, a harvester is dependent on boundary conditions e.g. on a relevant temperature difference or on sufficient sun radiation. In contrast, no energy deficiency occurs in the case of the display unit as a result of changing boundary conditions. It is continuously supplied with a constant amount of energy by an energy source. It is, thus, operated independently of the energy won by the harvester.

The energy supply of the display unit can advantageously occur via a process control system. For this purpose, the display unit is connected via one or more lines for energy supply from and data traffic with a process control system.

The energy harvester is, in such case, integrated into the sensor unit in a compact manner. Thus, the energy harvester is especially arranged in a housing of the sensor unit. In the case of a thermal energy harvester, this can ideally be arranged in the housing part, which isolates the temperature sensitive on-site electronics from the very hot or very cold pipeline. The pipeline represents then, for example, the heat source and the on-site electronics housing the heat sink, which via their separation and their heat conductivity properties produce the required temperature difference and therewith the heat flow required for the thermal energy harvesting.

As already described above, the data transfer can occur intermittently with transmission pauses, wherein length of the transmission pauses is predeterminable by a control apparatus. The control variable can be a preset time interval. In this time interval, enough energy should be collected, in order to enable the data transfer. Alternatively or supplementally, a control variable can be a preset energy limit value. To the extent that this is exceeded, a data transfer is automatically performed.

The vortex flow measuring device advantageously includes at least two operating modes. A first operating mode conducts a continuous or intermittent data transfer between the sensor unit and the display unit. Of course, during execution of the operating mode also a continued measuring of the mentioned process variable and/or composition of the measured medium can occur.

The second operating mode conducts a logout function in the case of energy deficiency of one of the communication means. To the extent that this logout function was executed and the sensor unit has properly logged out, the display element or, in given cases, also the process control system, knows that an interruption of the display and, in given cases, also the measuring of the process variable or composition of the measured medium is present due to an energy deficiency. In this way, the user obtains information that no defect of the measuring device is present, but, instead, only an interim energy deficiency.

It is advantageous when the sensor unit includes a data memory, in which measurement data, especially measured values, relative to the process variable to be ascertained are collected and provided in the case of a data transfer. The stored data packet can be transmitted when sufficient energy is available for transmission. Thus, phases with smaller energy yield can be advantageously bridged.

The sensor unit can also have an energy storer but such is not necessary in the case of sufficient energy yield.

The vortex flow measuring device can especially be used in an explosion protected area. A possible alternative to a harvester would be a battery. However, the application of batteries exactly in so-called Ex-regions is disadvantageous, since a battery provides initially a very high energy density. This must due to the safety specifications be correspondingly regulated down. For this, additional circuit components are necessary. A harvester delivers, more or less continuously, a low energy density. This is, to the extent that it is sufficient for transmission operation, directly consumed. A complex adapting of a too high energy density to the Ex-region need, consequently, in contrast to the case of a battery, not occur in the case of a harvester.

An energy harvester can be, for example, and preferably, a module, which wins energy from a temperature difference. Corresponding harvesters are known from US 2005/0208908 and from DE 20107112 U1, to whose disclosures comprehensive reference is taken. Alternatively, an energy harvester can also be a module, which wins energy from solar radiation. These examples are only by way of example. Also other energy harvesters can be applied.

The subject matter of the invention will now be explained in greater detail based on an example of an embodiment and with the aid of the drawing, the figures of which show as follows:

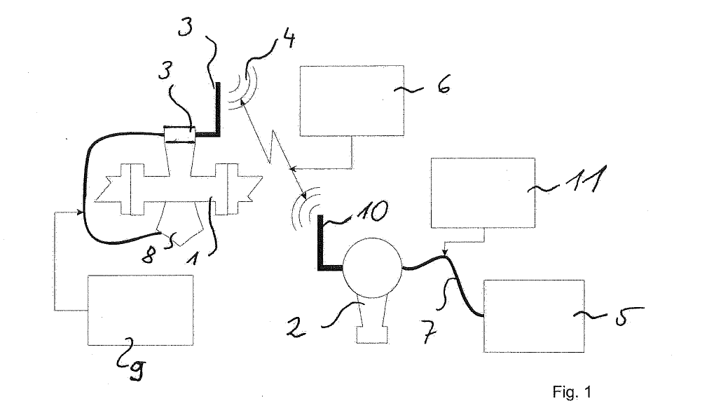

FIG. 1 a schematic representation of the construction of a vortex flow measuring device of the invention; and

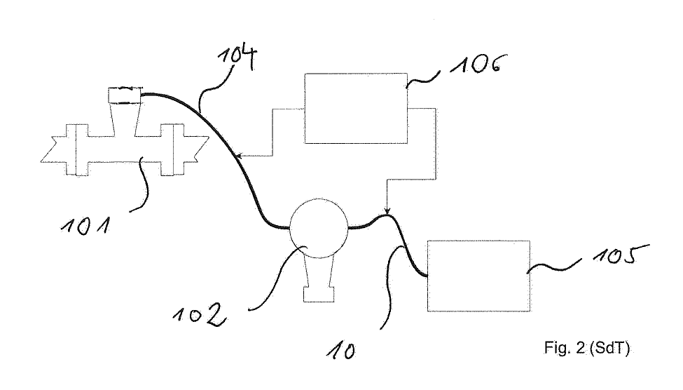

FIG. 2 a schematic representation of the construction of a field device according to the state of the art.

FIG. 2 shows the construction of a field device known per se and having a sensor unit 101 and a removed display unit 102, such as also could be applied for a vortex flow measuring device. The terminology, removed, means in this connection that the display unit 102 is spatially separated from the sensor unit 101. The separation can, in such case, be, for example, several meters. The electrical current supply of the vortex flow measuring device is provided by a process control system 105, which supplies the energy for the operation of the field device. The transmission of energy and data from the field device to the process control system 105 is enabled by a connecting cable 103, which is in communication with the display unit 102. Display unit 102 and sensor unit 101 are, in turn, connected by means of a cable 104. This assures data- and energy transmission to the sensor unit 101.

FIG. 1 shows a vortex flow measuring device of the invention with a sensor unit 1 and a removed display unit 2. Display unit includes a communication means 10, which in FIG. 1 is symbolized by a radio antenna. Electrical current supply 11 of the display unit 2 occurs via a process control system 5, which is connected with the display unit 2 via a line 7. Data transmission between the process control system 5 and the evaluation unit 2 can also occur via the line 7.

Communication means 10 of the display unit 2 is in its simplest embodiment a simple receiving unit. It can, however, also be embodied as a transmitting- and receiving unit.

Sensor unit 1 ascertains, depending on measuring principle, measured values, from which a process variable, a property of the medium and/or the composition of the measured medium are/is directly ascertainable or ascertainable by calculation.

A typical process variable is the flow. Sensor unit 1 includes an energy harvester 8, which during measuring wins energy 9 from the process, respectively the measured medium. There is an extensive literature concerning suitable energy harvesters in the field of process measurements technology. Thus, it is e.g. possible to win energy from pressure fluctuations of the process medium. Another opportunity for winning energy is offered by media with changing temperatures, thus e.g. in the case of cryogenic applications or superheated steam or hot gas applications. Here, the core of a harvester for energy winning can be a Peltier element. Proviso for use of a Peltier element is a thermal contact and a temperature difference, which causes a heat flow. In the simplest case, also paddle wheels can be applied for winning energy e.g. in the case of flow measurement, although this due to the flow resistance is not a preferred variant of an energy harvester.

Harvester 8 is, in such case, a component of the vortex flow measuring device, however, not absolutely a component of the sensor unit 1. Thus, it can in the case of flow measurement be arranged at any position on a pipeline and feed the sensor unit 1 with energy via an energy supply line. In an advantageous embodiment, the harvester 8 can, however, also be integrated in compact manner in the housing of the sensor unit 1.

Display unit 2 likewise includes a communication means 3, which in FIG. 3 is likewise only schematically shown as a radio antenna. The communication means 3 of the sensor unit 1 is in its simplest embodiment a plain transmitting unit. It can, however, also be embodied as a transmitting- and receiving unit.

As schematically indicated in FIG. 1, data transmission between the communication means occurs by radio signals 4. The subject matter of the invention is, however, not limited to radio connections, but can, instead, be expanded to other technologies for wireless data transmission. Utilized for the data transfer can be basically any suitable cableless (wireless) transmission standard (e.g. LAN, WAN, MAN, PAN or RFID). Especially suitable, however, due to the small energy consumption, are WPAN communication means, such as e.g. Bluetooth devices.

Display unit 2 includes in the simplest embodiment a display module, e.g. a display for information regarding the process measurement variable to be ascertained. Data transmission can, however, e.g. also occur via an acoustic signal or by means of an optical signal. The display unit can, however, also comprise yet other modules, for instance an evaluation module, which calculates from measured values the process variable to be ascertained and/or the composition of the measured medium. The arrangement of the evaluation module in the display unit 2, instead of in the sensor unit, is, in such case, especially advantageous, since the energy for the required computing power then does not have to be supplied at the sensor unit.

The vortex flow measuring device can additionally also comprise a plurality of sensor units, which can be connected with the display unit 1 via the cableless data connection.

The vortex flow measuring device can be operated in at least two operating modes, wherein

I a first operating mode executes a continuous or intermittent data transfer; and

II a second operating mode includes a logout function in the case of energy deficiency in one of the communication means.

The first operating mode has already been explained. In this operating mode, the device transmits data or is ready for data transmission “on demand”.

In the second operating mode, the sensor unit logs out at the display unit in the case of an energy deficiency. Thus, remaining energy can be used to transmit a signal, which tells the display unit that an energy deficiency is present. This information can then be transmitted to the process control system. The user then knows that no defect of the vortex flow measuring device is present but, instead, only an energy deficiency.

Besides the two above-described operating modes, the vortex flow measuring device can, of course, have still other operating modes. A third operating mode can signal a resting state, in which no measuring and no data transmission is occurring. The vortex flow measuring device is located, consequently, on stand-by. This operating mode is selected, for example, in the case of very small energy supply.

Additionally, the vortex flow measuring device can also have a fourth operating mode, with which the device back logs on and goes into action, to the extent that sufficient energy is available.

In an additional preferred embodiment, the display unit likewise includes a buffer. This enables the display of a measured value, a process variable, a composition and/or a property of the media in the case of the last data transfer. Optionally, also the point in time of the data transfer can be displayed, so that the user knows when the last data packet was transmitted and how current the displayed value is.

The vortex flow measuring device shown in FIG. 1 is especially suitable for flow measurement in steam lines. Steam is, as a rule, in any event produced for energy transport. It is, consequently, easily possible, e.g. with a thermopile, to win electrical energy from the heat energy of the steam. The dividing into a measuring electronics and an evaluating electronics suits this method for winning energy, since only a fraction of the total energy uptake of the measuring device is required for the operation of the measuring electronics. This part can easily be won from the process.

It would make only limited sense to supply the measuring electronics and the evaluating electronics with energy from the process and to transmit only the measurement result via a radio connection, for, as a rule, the measurement result is in some way further processed or at least plotted in a process control system. The further processing of the measurement results requires preferably a wired connection between the radio receiver, thus the display unit, and the further processing system, thus the process control system.

The above-described dividing of the signal (data) and energy flows is the most favorable solution both from an energy as well as also technical point of view.

The advantage from the technical point of view is especially that the display unit with the preferably integrated evaluating electronics is still connected functionally with the process control system even in the case of lack of energy supply from the process. There are then, indeed, no measured values available, but the measuring device can be further parametered and diagnostic reports are available (e.g. those reporting that temporarily no energy is available for operation of the measuring electronics).

If, in contrast, the entire measuring device would be operated exclusively with energy won from the process, no distinguishing between a temporary energy deficiency and a total failure of the device due to a defect would be possible.

In practice for flow measurement for steam applications, for example, a vortex counter can be utilized. The local measuring electronics, respectively sensor unit, of a vortex counter on a steam line is supplied with energy by a thermoelectric converter, which transforms heat into electrical energy. The raw signal is conditioned such that digital transmission is possible. The digitized signal is sent wirelessly to a receiver, here the communication means 3, which is connected with the actual evaluating electronics in the display unit 2. The evaluating electronics on its part uses the radio channel for parametering the measuring electronics (e.g. adjusting the filter, sampling rate, etc.). The evaluating electronics processes the transferred signal, so that the flow measurement variable (e.g. volume flow rate, mass flow, etc.) desired by the user can be shown in the display and/or forwarded in a usual transmission system, e.g. 4 to 20 mA electrical current loop, Profibus, FF, etc., to a process control system or the like. The display unit with integrated evaluating electronics is, in such case, supplied with energy by the process control system.

1-15. (canceled)

16. A vortex flow measuring device for ascertaining a flow related process variable comprising:
at least one sensor unit; and
one display unit, wherein:
said sensor unit and said display unit are arranged spatially separated from one another;
said display unit and said sensor unit are provided with one or more communication means, which are designed for establishing a wireless data transfer route between said display unit and said sensor unit of the vortex flow measuring device; and
at least said communication means of said sensor unit is operated by means of an energy harvester.

17. The vortex flow measuring device as claimed in claim 16, wherein:
the maximum data transmission rate of the wireless data transfer is equal to or less than 4 Mbit/s, especially 3 Mbit/s.

18. The vortex flow measuring device as claimed in claim 16, wherein:
the maximum separation between said sensor unit and said display unit is equal to or less than 25 m.

19. The vortex flow measuring device as claimed in claim 16, wherein:
the maximum data transmission rate is equal to or less than 1024 Mbit/s; and
maximum separation between said sensor unit and said display unit amounts to less than or equal to 15 m.

20. The vortex flow measuring device as claimed in claim 16, wherein:
said communication means is a WPAN communication means.

21. The vortex flow measuring device as claimed in claim 16, wherein:
said display unit is connected with a process control system via at least one line for energy- and/or data traffic.

22. The vortex flow measuring device as claimed in claim 16, wherein:
said energy harvester is a component of said sensor unit and is especially arranged in a housing of said sensor unit, preferably between the pipeline and the housing of the on-site electronics.

23. The vortex flow measuring device as claimed in claim 16, wherein:
data transfer occurs intermittently with transmission pauses; and
the lengths of the transmission pauses are predeterminable by a control apparatus.

24. The vortex flow measuring device as claimed in claim 16, wherein:
data transfer occurs only based on retrieval by the operator.

25. The vortex flow measuring device as claimed in claim 16, wherein:
the vortex flow measuring device has at least two operating modes;
I) a first operating mode which executes a continuous or intermittent data transfer; and
II) a second operating mode which includes a logout function in the case of energy deficiency in one of said communication means.

26. The vortex flow measuring device as claimed in claim 16, wherein:
said sensor unit includes a data memory, in which measurement data relative to the process variable is collected and provided in the case of a data transfer.

27. The vortex flow measuring device as claimed in claim 16, wherein:
said sensor unit is operable, especially exclusively, by said energy harvester.

28. The vortex flow measuring device as claimed in claim 16, wherein:
energy supply of said display unit occurs independently of energy won by said harvester.

29. The vortex flow measuring device as claimed in claim 16, wherein:
said sensor unit has no interim energy storer.

30. The use of the vortex flow measuring device as claimed in claim 16 in an explosion protected region.
